(19) United States
(12) Patent Application Publication
(10) Pub. No.: US 2008/0251366 A1
(43) Pub. Date: Oct. 16, 2008

(54) Locking push-button switch

(76) Inventors: Michael Geppert, Bingen (DE); Andreas Dietrich, Guldental (DE)

Correspondence Address: DELPHI TECHNOLOGIES, INC., M/C 480-410-202, PO BOX 5052, TROY, MI, 48007, US

(21) Appl. No.: 11/894,431

(22) Filed: Aug. 21, 2007

(30) Foreign Application Priority Data
Aug. 23, 2006 (EP) 06017506.4

(51) Int. Cl. H01H 15/06

(52) U.S. Cl. 200/524

(57) ABSTRACT

A locking push-button switch comprises a plunger that is displaceable relative to a component when a force is applied, wherein a latch interacting with a cardioid cam is arranged between the component and the plunger. A friction brake is assigned to the latch.

### TECHNICAL FIELD

The invention relates to a locking push-button switch with a plunger that can be displaced relative to a component when pressure is applied, wherein a latch interacting with a cardioid cam is arranged between the component and the plunger.

### BACKGROUND OF THE INVENTION

DE 43 09 711 C1 discloses a steering column switch with a switch lever that carries on its free end a spring-loaded push button for applying a force onto an electrical switching circuit. The push button is in active connection via a spring-loaded connecting rod with a transverse lever, which lies in the rotational axis of the switch lever and which is supported so that it can pivot, and which is connected on its pivoting end to a spring-loaded switch element, which has a cardioid cam in which a housing-side spring-mounted locking latch engages. The locking latch has a latch foot, which becomes wider relative to a latch arm and is centered in an opening, and which is contacted by a compression spring from below, so that the latch follows the course of the cardioid cam reliably in each position of the steering column switch or switch lever. Without the compression spring there is the risk that the locking latch will assume a position in which it runs, for example, against the normal direction of rotation about the cardioid cam or that it interlocks in the guide for a corresponding inclination of the steering column switch or switch lever. Consequently, error-free switching is no longer guaranteed. However, the space requirements are problematic for the arrangement of compression springs, the locking latch, and the cardioid cam.

### SUMMARY OF THE INVENTION

The problem addressed by the invention is to create a locking push-button switch of the type named above, which can be used in a compact construction in an arbitrary position.

According to the invention, the problem is solved in that a friction brake is assigned to the latch.

Due to the friction brake, unintentional displacement of the latch due to its own weight in, for example, an installation- or function-related inclined position is excluded. The latch is aligned for the mounting of the push-button switch according to the cardioid cam and then pressure is applied by the friction brake. A subsequent change in position of the push-button switch does not affect the position of the latch relative to the cardioid cam, which changes only when a force is applied to the activation element. In the sense of the invention, the friction brake is not to be understood as pressing the latch into an opening of a part of the push-button switch. Instead, the friction brake comprises at least one component generating or transmitting the braking force.

Preferably, the latch is formed as an angled rod, whose one end engages so that it can pivot in a bore and whose other end engages in the cardioid cam, wherein the friction brake comprises a compression spring, which applies a force to the end of the latch inserted into the bore. Here, for example, the end inserted into the transverse bore is dimensioned long enough that it extends completely through the component and projects on both sides, so that the compression spring can be supported on it. The braking effect is generated based on the friction force created between the latch and the component under the spring effect. Obviously, it is possible to assign another function to the compression spring, for example, forcing the activation knob back into its return position.

Preferably, the friction brake comprises a pressure part arranged between the compression spring and the latch. The pressure part can have a relatively large contact surface for guaranteeing the braking effect especially both on the side assigned to the latch and also on the compression-spring side. In addition, the pressure part can be formed as a separate component like a brake pad and the latch can be compression-spring-loaded. For the use of a relatively soft material, both a good braking effect and also noise damping are realized. Obviously, the pressure part can be displaced relative to the latch.

Preferably, on the side facing the latch, the pressure part has a recess adapted to the cross section of the latch. Preferably, the pressure part is made from a plastic.

In its construction, the latch is angled twice for a space-saving construction of the switch mechanics. The latch can have a Z-shaped structure. For a space-saving arrangement, the bends point in the same direction. Consequently, the latch has an essentially U-shaped structure.

According to another refinement, the compression spring contacts an activation knob with a biasing stress. The compression spring extends between the activation knob and the latch, wherein the pressure on the latch is increased when the activation knob is activated.

To hold the activation knob in a locked switch position, preferably the activation knob is connected to the plunger with the cardioid cam.

In another construction, a component supporting the latch is a lever of a steering column switch, on whose free end the activation knob is supported. The lever itself can obviously be supported with its foot, so that it is displaceable or can support a rotary switch in order to switch a plurality of functions.

Preferably, the pressure part is constructed in one piece with the lever. Through a corresponding cross-sectional narrowing, a moving pressure part that can pivot especially relative to the lever and the latch is to be realized, which applies a force on the latch in a compression-spring-loaded way, which is also supported against the lever. In this construction, the transverse bore can extend, for example, through half the cross section of the lever, while the other half of the cross section of the lever is formed by the pressure piece. Consequently, the latch is tensioned between the lever and the pressure piece.

It is understood that the features named above and still to be explained below can be used not only in the specified combination but also in other combinations. The scope of the invention is defined only by the claims.

### BRIEF DESCRIPTION OF THE DRAWINGS

The invention is explained in more detail below using one embodiment with reference to the associated drawings. Shown are:

FIG. 1, a perspective partial view of a steering column switch with a push-button switch according to the invention,

FIG. 2, a top view onto the steering column switch according to FIG. 1,

FIG. 3, an enlarged view of a detail III according to FIG. 2 in a rotated position,

FIG. 4, another perspective partial view of the steering column switch according to FIG. 1, and

FIG. 5, a side view of the steering column switch according to FIG. 1.

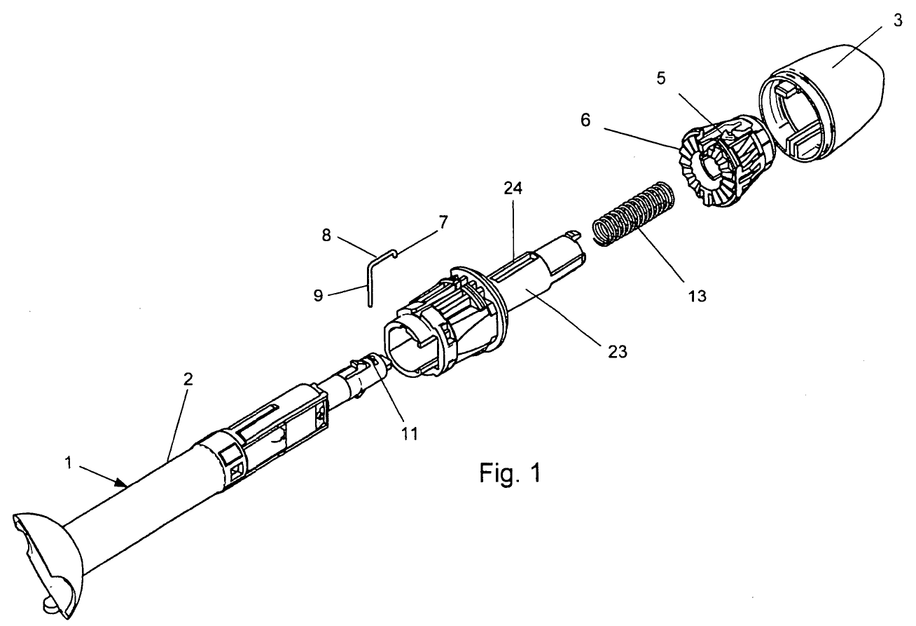

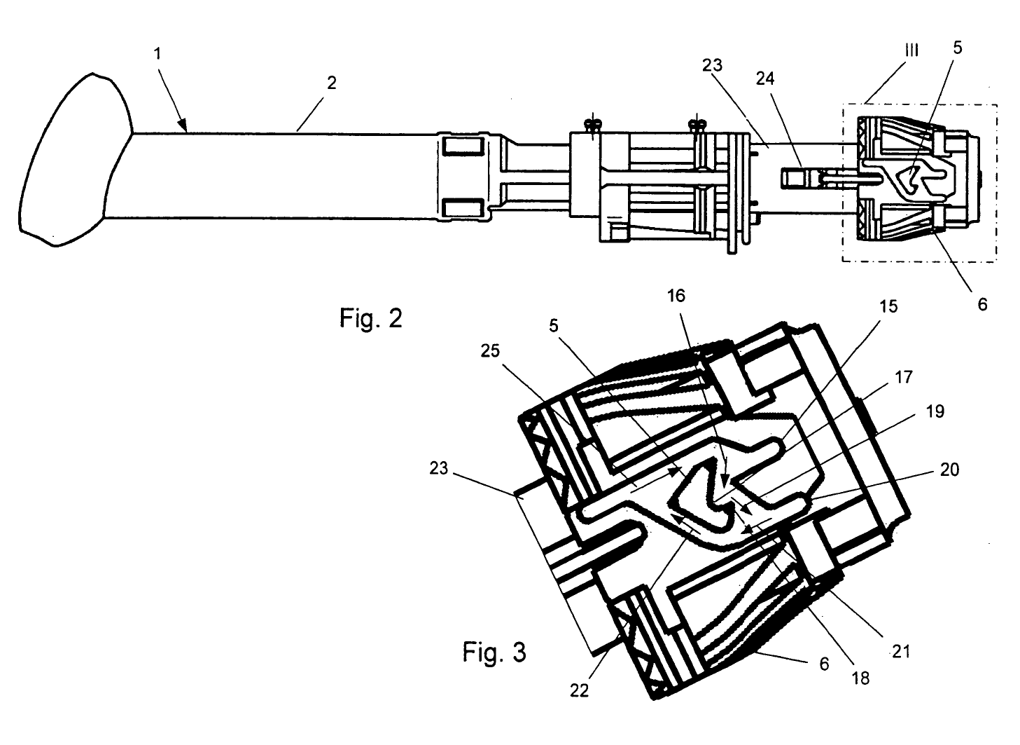

### DESCRIPTION OF THE PREFERRED EMBODIMENT

The steering column switch comprises a component 1, which is constructed as a lever 2 supported on the foot side and on whose free end an activation knob 3 of the push-button switch 4 is supported, wherein the activation knob 3 is connected to a plunger 6 with a cardioid cam 5.

To hold the activation knob 3, that is displaceable relative to the lever 2, locked in a forced position, one end 7 of a twice-angled latch 8, whose other end 9 is supported so that it can pivot in a bore 11 running transverse to the longitudinal axis 10, engages in the cardioid cam 5. So that the latch 8 does not pivot uncontrollably into an arbitrarily inclined position of the lever 2, a friction brake 12, which comprises a biased compression spring 13 and a pressure part 14 arranged between one end of the compression spring 13 and the latch 8, is assigned to the latch 8, wherein the other end of the compression spring 13 applies a force to the activation knob 3. The pressure part 14 is formed in one piece with the lever 2, in which a cross-sectional narrowing is provided, based on which a pivoting of the compression spring-loaded pressure piece 14 relative to the lever 2 and thus pressure application on the latch 8 is possible.

Due to the effect of the compression spring 13, the latch 8 maintains the position assumed in the installation or at the end of a switching process and does not automatically pivot due to its own weight. A switch piece 23, which is connected to the plunger 6 and which has an elongated hole 24, through which the end 9 of the latch 8 assigned to the lever 2 projects, is supported on the lever 2.

When a force is applied to the activation knob 3 against the effect of the compression spring 13, the latch 8, which receives a force from the friction brake 12, follows the direction of the arrow 25 around the cardioid cam 5 until it reaches an indentation 15, which represents a stop for the application of the force. After releasing the activation knob 3, the latch 8 slides from the indentation 15 and follows the direction of the arrow 16 until it lies in a recess 17 of the cardioid cam 5, which represents the locked position of the activation knob 3. If force is applied to the activation knob 3 again, the latch 8 climbs over the peak 18 of the cardioid cam 5 and follows the direction of the arrow 19 into an indentation 20. After releasing the activation knob 3, the latch 8 slides in the direction of arrows 21, 22 until the activation knob 3 is located in its unlocked starting position.

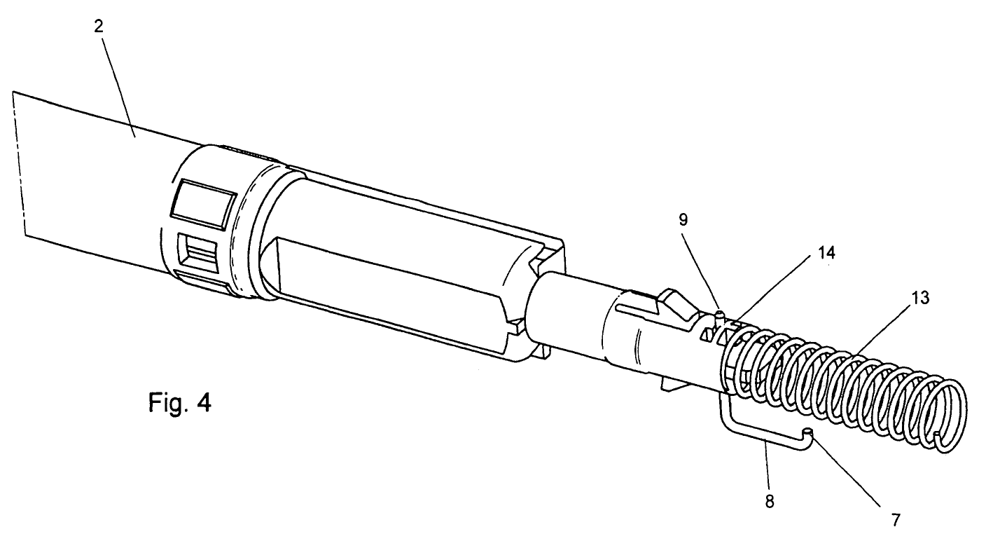

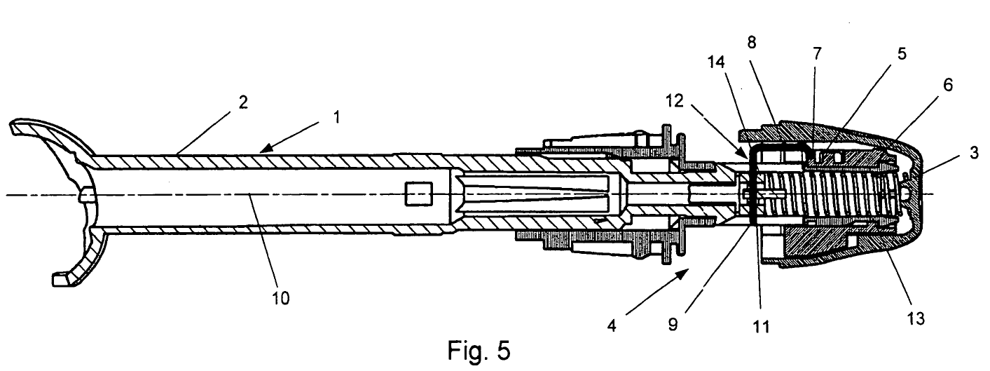

For a push-button switch inclined according to FIG. 3, in which no friction brake 12 is assigned to the latch 8, there is the risk that the latch 8 will pivot due to its own weight so that it moves around the cardioid cam 5 against the direction of the arrows 22, 21 with the end 7 assigned to the cardioid cam 5 when a force is applied to the activation knob 3 and reaches the indentation 20 in the pressed final position of the activation knob 3. After the activation knob 3 is released, the latch 8 slides in the direction of the arrows 21, 22 into its starting position, and an error-free function of the push-button switch 4 is not guaranteed.

What is claimed is:

1. Locking push-button switch comprising:
a plunger that is displaceable relative to a component when a pressure is applied; a latch interacting with a cardioid cam disposed between the component and the plunger, and a friction brake operative to limit displacement of the latch.

2. Push-button switch according to claim 1, wherein the latch is constructed as an angled rod, whose one end engages so that it can pivot in a bore and whose other end engages in the cardioid cam, wherein the friction brake comprises a compression spring, which applies a force to the end of the latch inserted into the bore.

3. Push-button switch according to claim 1, wherein the friction brake comprises a pressure part arranged between the compression spring and the latch.

4. Push-button switch according to claim 3, wherein the pressure part has a recess adapted to the cross section of the latch on the side facing the latch.

5. Push-button switch according to claim 3, wherein the pressure part is made from a plastic.

6. Push-button switch according to claim 1, wherein the latch is angled twice.

7. Push-button switch according to claim 6, wherein the angles point in the same direction.

8. Push-button switch according to claim 2, wherein the compression spring contacts an activation knob with a biasing stress.

9. Push-button switch according to claim 8, wherein the activation knob is connected to the plunger with the cardioid cam.

10. Push-button switch according to claim 1, wherein a component supporting the latch is a lever of a steering column switch, on whose free end the activation knob is supported.

11. Push-button switch according to claim 1, wherein the pressure part is formed integrally with the lever.
